(19) United States
(12) Patent Application Publication
(10) Pub. No.: US 2016/0177566 A1
(43) Pub. Date: Jun. 23, 2016

(54) ROOM ORGANIZING SYSTEM

(71) Applicant: KONINKLIJKE PHILIPS N.V., Eindhoven (NL)

(72) Inventors: FEDERICO GABRIELE TREVIA, EINDHOVEN (NL); ADAM HENRIKSSON, EINDHOVEN (NL)

(21) Appl. No.: 14/910,031

(22) PCT Filed: Aug. 8, 2014
(86) PCT No.: PCT/EP2014/067121

§ 371 Date: Feb. 4, 2016

(30) Foreign Application Priority Data
Aug. 12, 2013 (EP) 13180127.6

(51) Int. Cl. E04B 2/88; E06B 9/24

(52) U.S. Cl. CPC E04B 2/88; E06B 9/24

(57) ABSTRACT

A room organizing system (100) and a method for shaping a living area in a given primary room (101). In one embodiment, a primary room of e.g. a hospital may be provided with a plurality of controllable curtains (110) that can be extended from the ceiling (103) down to the floor (102) to create separate compartments (A). Extension and retraction of the curtains (110) is controlled by a controller (140) based on detection signals (s) that indicate a current or an intended usage of the primary room. If for example weight sensors (130) indicate the presence of a person at a particular location of the primary room, a privacy providing compartment may be created around said person by extending the associated curtains (110).

### FIELD OF THE INVENTION

The invention relates to a room organizing system and a method for shaping a living area in a given primary room, for example in a home environment, a hospital, or shop.

### BACKGROUND OF THE INVENTION

The U.S. Pat. No. 5,680,893 discloses a decorated panel for providing privacy to an area such as a pool. The panel can manually be installed and adapted to the location at hand.

The US 2009/254222 discloses a shade system in which motorized window coverings are automatically closed or opened depending on information about weather conditions provided by sensors. Moreover, motion sensors may be provided for detecting motion of users.

### SUMMARY OF THE INVENTION

Based on this background it would be desirable to have means that allow for a more versatile organization of living areas.

This object is achieved by a room organizing system according to claim 1 and a method according to claim 2. Preferred embodiments are disclosed in the dependent claims.

According to its first aspect, an embodiment of the invention relates to a room organizing system for shaping or structuring a living area in a given room or space, the latter being called “primary room” in the following. The system comprises the following components:
At least one curtain that is controllable between an extended state and a retracted state, wherein the curtain subdivides the primary room into at least two compartments when being extended.
At least one sensor for providing detection signals related to a state of usage of the primary room.
A controller for controlling the curtain in dependence on the detection signals of the sensor.

The primary room that is shaped by the system may be any given outdoor space or, preferably, an indoor space such as a room or hall in a building. Often the organizing system will be permanently installed in the primary room, though it is also comprised by the invention that the organizing system may be removable to allow for a temporarily limited application.

A “compartment” shall be a sub-space of the primary room that can be used by a person. A compartment is hence large enough to accommodate at least one person, preferably a person together with objects such as furniture and/or a group of persons.

The term “curtain” shall generally denote an element that can provide a border or wall which can physically separate one compartment from a neighboring one. The curtain will typically be opaque to separate neighboring compartments optically. Additionally or alternatively, it may be substantially airtight and/or sound absorbing. While a rigid curtain is also comprised by the invention, it is preferred that the curtain is flexible, allowing for a space-saving rolling up. A flexible curtain may for example be realized by fabric.

The extension and retraction of the curtain will usually take place in a vertical or perhaps slightly inclined (about ±30°) direction, though other arrangements including horizontal ones are possible, too. The curtain will typically be mounted at the ceiling of the primary room, from where it can be extended downwards in vertical direction, preferably completely down to the floor. Other options include a mounting of the curtain in a side wall or in the floor of the primary room from where it can extend into said room if desired. Though it is possible that the curtain can assume only two states, i.e. fully retracted and fully extended, it is preferred that any or at least some intermediate states can be assumed, too, for example a halfway extension of the curtain.

The detection signals may be realized in any way and modality, for example as electrical signals or as digitally coded data. They may be communicated from the sensor to the controller in any appropriate way, for example by wire or wirelessly.

The “state of usage” that is related to or encoded in the detection signals may correspond to a current state of usage or, preferably, some intended (future) state of usage. Recreation and relaxation in a private atmosphere are examples of typical usages.

According to a second aspect, an embodiment of the invention relates to a method for shaping a living area in the primary room, said method comprising the following steps:
Sensing a state of usage of the primary room.
Controlling the extension and retraction of at least one curtain according to the sensed state of usage, wherein the curtain subdivides the primary room into at least two compartments when being extended.

The method comprises in general form the steps that can be executed with the organizing system described above. Explanations and definitions provided for the organizing system are therefore analogously valid for the method, too, and vice versa.

The organizing system and the method have the advantage that they allow for a flexible and automatic shaping of a larger room according to the needs of its user(s). A user looking for recreation can for example go to a particular location of the primary room, thus initiating the extension of curtains around him or her to create privacy in a compartment of the room.

In the following, various preferred embodiments of the invention will be described that relate to both the organizing system and the method described above.

In one preferred embodiment, the curtain is provided in a mounting system that allows for a translation, a rotation, and/or a lengthening of the curtain. The mentioned “translation” and “lengthening” of the curtain usually take place in horizontal direction or at least with some (preferably dominant) horizontal component, while the “rotation” preferably takes place about some vertical axis. The translation, rotation, or lengthening of the curtain will therefore typically change the curtain's arrangement when viewed in a vertical projection onto the floor plan of the primary room. In general, the “lengthening” of the curtain is assumed to take place perpendicularly to its “extension/retraction”.

The aforementioned changes of translation, rotation or lengthening of the curtain may be effected manually by a user or at least take place under explicit control of the user. In a preferred embodiment, these changes may at least partially be controlled automatically in dependence on the detection signals provided by the sensor. If the sensor indicates for example that a user wants to relax at some location within the primary room, one or more curtains can automatically be moved (horizontally) to said location until they surround it and, after being (vertically) extended, separate a compartment from the surroundings.

The organizing system and the method may use just a single curtain. Preferably, there is however a plurality of curtains that are independently controllable according to the described principle, i.e. in dependence on the detection signals. Explanations provided for “the curtain” are therefore analogously valid for each curtain of such a plurality, too. When there are several curtains, at least two of them may be arranged parallel and close to each other, such that they effectively provide the same subdivision of the primary room when being extended while having different surfaces (e.g. different ornaments or colors).

In a preferred embodiment using a plurality of curtains, said curtains allow for different patterns of subdivision of the primary room into compartments. The curtains may for example be arranged in some cellular or grid pattern in which each cell wall is separately and independently controllable. This enables configurations in which each cell is a compartment separated from the neighboring one as well as configurations in which neighboring cells are joined to commonly form one compartment.

The compartments that are created when the curtain is extended may at least partially be bordered by other elements than said extended curtain, for example by a permanent wall of the primary room. In a preferred embodiment, at least one compartment can however be created that is completely bordered by one or more controllable curtains. A compartment that is completely bordered by a single extended curtain can for example be generated if said curtain encircles and inner area (e.g. if it has the shape of a cylinder).

There are many possibilities how a current or intended state of usage of the primary room can be detected. In a preferred embodiment, the presence, the identity, the state, the location, the orientation, the movement and/or the activity of a user or of an object can be detected.

The detected presence or identity of the user or the object may directly correspond to a state of usage, or such a state of usage can be inferred from it. The primary room can for example be configured based on the identity of the person(s) in it and/or the objects which are put inside.

Detection of a state can be applied if an object having distinguishable states or a person are considered. In case of a person, a biofeedback system can for example be created, allowing for an adaption of the ambient experience within the enclosed space to the (mental) state of a user.

Detection of a movement may be a simple binary detection (user/object is moving or not moving), but preferably comprises more information such as the movement direction and/or velocity. Movement of a person in a particular direction can for example indicate that the person wants to leave or enter a compartment, in which case the curtain(s) in movement direction should be retracted.

Detected “activities” of a person other than movement may for example be working (at a stationary place), reading, or relaxing. Determination of the location of a person or object (e.g. a chair, a table, or a couch) can be used to determine the appropriate location and size of a privacy compartment within the primary room.

In general, any sensor that can provide information from which the state of usage can be derived can be applied. In a preferred embodiment, the sensor may comprise at least one element selected from the group consisting of a weight sensor, proximity sensor, sensor of a physiological parameter, wireless communication device, RFID reader, or camera (i.e. the sensor may for example comprise a camera and several weight sensors). With these sensors it is particularly possible to execute the aforementioned detection of the presence, identity, state, location, movement, orientation and/or activity of a user or object.

The presence of persons or objects may particularly be detected with the help of RF tags or active badges, possibly with a local positioning system, ultrasound or 3D cameras. Additionally or alternatively an application running on a mobile device such as a smartwatch or smartphone can be used. The location detected by this application may for example be communicated to the controller of the room organizing system.

Identification of a person can for example be achieved with sensors that allow for face recognition, or via smart cards or the like. The sensors may further comprise an (active or passive) RFID-tag reader that allows for an identification of persons and objects in or close to the primary room.

A proximity sensor might be located in at least one curtain to control it (initiating for example a retraction of the curtain if someone approaches).

Sensing of a physiological parameter may optionally comprise the usage of camera techniques to measure heart rate, stress, breathing, or the like. Additionally or alternatively, a (preferably wireless) sensor that is body worn e.g. inside a bracelet that measures activity or heart rate can be used to measure one or more physiological parameters. The measured physiological parameters may particularly be parameters that allow for inferring the mental state of a user.

According to a further development of the organizing system and the method, an input device may be provided via which a user can deliberately affect the control of the curtain. Thus an extension or retraction of the curtain can be initiated by the user even if no such activity is commanded automatically based on the detection signals. Moreover, it is preferred that the command provided by the input device can override an automatic control based on the detection signals, thus giving the user inputs highest priority. The input device may for example comprise a remote control that can wirelessly communicate with the controller. Such a remote control can be a device of its own or be a personal mobile device on which an appropriate program runs, for example a mobile phone or tablet with an associated application. Other embodiments of an input device may comprise a voice control or gesture control. Gestures such as up and down hand movements or pointing gestures may be detected via a camera and evaluated by the controller. In a preferred embodiment, pre-programmed settings may be initiated with the input device (i.e. the user needs not explicitly control the extension of each individual curtain but can for example choose from several menu items). Additionally or alternatively, personal programs or settings may be uploaded to the controller from the input device.

Additionally or alternatively, a user may provide an input to the controller e.g. by placing objects on the floor that mark an outline of a space. The curtains may then extend to complete that space (programming by example). The objects and their position and/or orientation can for example be detected with a camera system.

Besides one or more curtains, other components can be controlled according to the detected state of usage of the primary room, too. In particular, at least one of a light source, a sound system, an image projection system, a climate control, a scent release, and a tactile feedback may be provided that are controlled according to the detected state of usage (e.g. there may be several such light sources and a sound system).

With respect to the aforementioned light source(s), it is preferred that at least one individually controllable light source is provided for each compartment that can be generated by extending the curtain(s) in the primary room to allow for its individual lighting. Preferably, brightness and/or color of the light source(s) can be controlled. Moreover, the light source will typically be mounted at the ceiling of the primary room, though it may be arranged at other locations, too.

The mentioned image projection system may preferably be arranged such that it allows for the projection of images onto the extended curtain. Thus compartments with particular themes such as a relaxing environment can be created.

The climate control may generally comprise any means that allows for changing and/or adapting temperature, airflow, humidity and/or any other climate-related parameter of interest.

Tactile feedback may for example be provided in the floor and/or via airflow.

Furthermore, light sources such as LEDs may be embedded in the curtain(s) to render themes. Additionally or alternatively, the curtains may comprise embedded speakers and/or touch sensors for interactivity.

In a preferred embodiment, the creation of the (at least one) compartment in the primary room may provide conditions of wellness and/or relaxation.

The invention further relates to the use of the described room organizing system for shaping an area in a home environment, in a hospital, in an office, at an exhibition, in a shop, in a restaurant, in a theater, or in other public spaces. In all these cases it is advantageous if one or more compartments of a larger room can automatically be separated based on desired particular usages. In more detail, the following applications are possible:

In a hospital environment in an examination room the room organizing system can provide a more flexible, efficient and intelligent alternative to the current curtain systems that are in use now. Depending on the procedure, or staff that is examining a patient, the curtains can create a space giving the necessary privacy and working conditions.

Also in hospitals the system can be used in recovery areas, preoperative holding areas, patient wards or emergency/acute care rooms. In an oncology department in a hospital the room organizing system can be used to create an active relaxation or chill out room.

The principles can be applied to create relaxing spaces in for example sleep disorder centers (sleep labs). For certain sleep therapy people need to learn how to relax and wind down. The room organizing system can provide the space for this together with special lighting.

In a shopping environment the system offers a flexible way to create showcase areas where products are on display and could be experienced by customers. Also based on the presence of people this space could configure itself to create an optimal environment for experiencing the product (e.g. a car).

In clothing shops, the changing rooms could benefit from the invention by offering dynamic resizable spaces with dynamic light that offers the best possible atmosphere for trying out new cloths.

Also in a shop the system can be linked to a crowd monitoring system (e.g. using cameras). To regulate the flow of people to certain parts of the shop the system can (automatically) adapt the space using curtains.

Also the behavior of the curtains could be linked to movable display units for products. When these are move, the ceiling lights and curtains can adapt to create the environment around the display unit. Also curtains could indicate which cash registers are open for checkout.

In restaurants, bars etc., the system can be used to create more private areas e.g. for groups. Also when there are not so many people, the curtains could be lowered to create a cozier, atmospheric space.

In a stage of a theater the system could be applied in a play or in performances. Also it may be used in art installations.

In offices the “open office” floorplan can be adapted based on the projects that are going on, or people that need to work together or have more privacy. In this way the organizing system accommodates the needs for flex workers and creates privacy (e.g. for a video phone call or breastfeeding) and spaces to work together and/or concentrate. Also in a row of desks, a person can create a “private bubble” to work in, which gives more privacy too (e.g. for video/telephone calls).

In a living room such a system can be used as alternative to room dividers to create different spaces such as for watching TV, dining, etc. Also when an activity like watching a movie takes place the space could be optimized in size for the best sound and image experience.

The system can further be applied in public spaces like airports, museums, schools etc. It can be used to create temporary (waiting) spaces that resize based on the amount of people, organize the flow of people, creating thematic spaces etc.

Also the curtains can be used to indicate where waiting lines are and/or where to go to enter a plane, check in at a desk etc. To attract people the curtains could have printed advertisements on them. The behavior of these kinds of curtains could be linked to the movement of people.

### BRIEF DESCRIPTION OF THE DRAWINGS

These and other aspects of the invention will be apparent from and elucidated with reference to the embodiments described hereinafter.

In the drawings:

FIG. 1 schematically shows a perspective view of an organizing system according to a first embodiment of the invention;

FIG. 2 shows a top view onto the organizing system of FIG. 1;

FIG. 3 shows the organizing system of FIG. 1 in another state of usage;

FIG. 4 shows a top view onto a second embodiment of an organizing system comprising a radial arrangement of curtains that can be translated and rotated.

Like reference numbers or numbers differing by integer multiples of 100 refer in the Figures to identical or similar components.

### DETAILED DESCRIPTION OF EMBODIMENTS

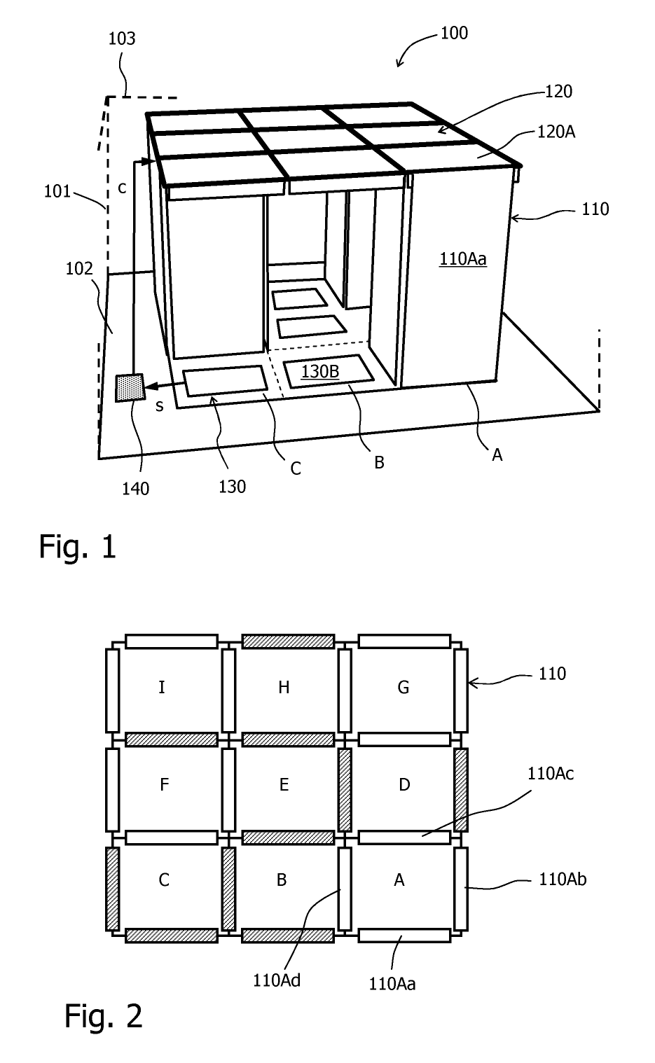

FIG. 1 schematically shows a perspective view of a room organizing system 100 according to an embodiment of the present invention. The system can be used for selectively creating different compartments A, B, C, . . . in a given “primary room” 101, for example in a large room or hall at home, in an office, or in a hospital. The borders of the primary room 101 are only roughly indicated by dotted lines. The primary room 101 provides a floor 102 and ceiling 103, between which the mentioned organizing system 100 is arranged. In the shown for example, this organizing system comprises the following components:
A set of controllable curtains 110 that are mounted at the ceiling 103 and that can individually be extended from the ceiling 103 down to the floor 102 under the control of a controller 140. The curtains are generally denoted by reference numeral “110”; if a particular one shall be referenced, this reference sign is augmented by symbols indicating the location (cf. FIG. 2: reference sign “110Ab” denotes, for example, a curtain located at side “b” of compartment “A”).
A plurality of light sources 120. Again, a general reference numeral, “120”, is used for the light sources in parallel to individual reference signs, e.g. “120A”, that additionally indicate their location. Though the light sources 120 are shown to be mounted at the ceiling 103, other arrangements of light sources are possible, too. The light sources 120 may preferably be multiple colored and/or Wi-Fi controlled.
A plurality of sensors (generally denoted as “130” or individually denoted as “130B” etc.) for providing detection signals “s” that are related to the current and/or to the intended usage of the primary room 101.
The mentioned controller 140 that receives the aforementioned detection signals s and issues commands c for controlling the extension and retraction of the curtains 110 in dependence on the detection signals.

The shown embodiment of the organizing system 100 has particularly a grid structure which is separately illustrated in a top view in FIG. 2. The organizing system subdivides the primary room into a grid of 3×3 cells or compartments A, B, C, . . . I (if all curtains are extended). The size of each compartment may for example be about 4.5 m×4.5 m. Individually controllable curtains 110 are located at the each of the four borders “a”, “b”, “c”, and “d” of each compartment, wherein two neighboring compartments typically share a common curtain (the curtain 110Ac at the back side of compartment A may hence for example be identical to the curtain denoted “110Da” at the front side of neighboring compartment D).

A person may want to use a bigger space corresponding to two connected cells, while also single cells can be used, enabling multiple people to use the environment individually at the same time. A corresponding shaping of the primary room is shown in FIG. 1, in which some of the curtains 110 are extended from the ceiling down to the floor such that one large compartment comprising two cells (I and F) and two smaller compartments consisting of one cell each (A and G) are created. The extended curtains are shown in lighter color in FIG. 2. To mention just one other possibility, the space may be enlarged to create a single compartment from all nine cells (lowering only the outer curtains). This can be useful for creating a space that is used by multiple people at the same time.

The extension or retraction of curtains 110 is automatically controlled by the controller 140 based on the detection signals s provided by the sensors 130. In the shown example, weight sensors 130 are used that are integrated into the floor 102. In particular, one weight sensor 130 may be integrated into the piece of floor of each grid cell (e.g. weight sensor 130B in cell B etc.). Moreover, further weight sensors may be disposed around the cells (not shown). Preferably, the weight sensors 130 are direction sensitive such that not only the presence but also the movement direction of a user P can be detected. Each weight sensor 130 may for example comprise a middle sub-sensor and four adjacent sub-sensors in four directions. The sensor floor enables detecting where somebody is standing and if he/she is moving to an adjacent space. In this case, the associated curtain may move up. In general, the system may comprise a sensor floor, proximity sensors, (3D) camera(s) (and video processing) or the like by which activity and/or presence of people can be detected.

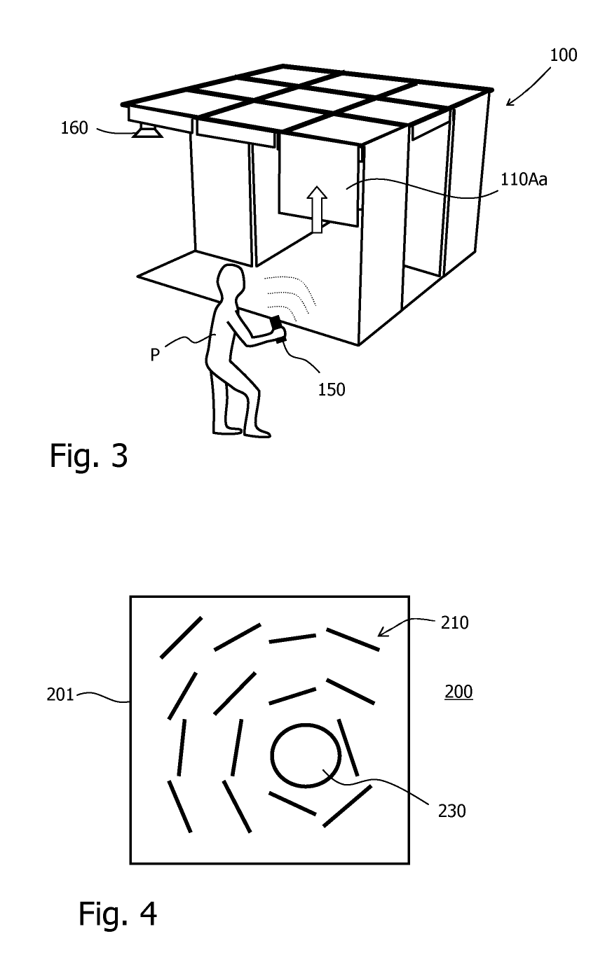

For example, FIG. 3 illustrates that the approach of a user P is detected (e.g. by weight sensors in the floor below or by proximity sensors, not shown) and induces, via the controller 140, an automatic retraction of the nearest curtain 110Aa, allowing the user to enter the compartment (A) behind.

FIG. 3 further illustrates that the user P may carry an input device such as a (preferably wireless) remote-control 150 with which he or she can actively transmit commands to the controller 140. The command from the input device 150 may override the automatic control and for example stop retraction of the curtain 110Aa. Other interactive controls may comprise voice control or objects that are brought into the space and that trigger events (e.g. by their simple presence and/or by emitting particular signals).

Moreover, a sound system 160 embedded in the ceiling of the primary room is visible in FIG. 3. This sound system may preferably be controlled based on the detection signals, too. Additionally or alternatively, the sound system or parts thereof may be disposed at other locations, too, for example be embedded in the floor.

Furthermore, objects with LED lights and/or sound capabilities may be brought into the space covered by the organizing system 100. Additionally or alternatively, physical objects may be put somewhere on the sensor floor 102, marking a space where curtains shall come down to enclose it. This allows for designing the space by just putting (decorative and/or functional) objects onto the floor. Preferably, not only the presence and location of such objects is determined, but also the identity or type of the object. For example, if somebody places a relaxing chair in the primary room, the chair can be detected and identified as “relaxing chair”, whereupon the curtains may come down and/or relaxing meditation music is played. Or when a couch is placed inside the space, the lights can adapt differently and not all curtains go down.

In a preferred application of the system 100, an ambient experience space is created with the ceiling carrying curtains that are computer controlled. Based on the activity or presence of people, the environment may automatically adapt in such a way that it creates a more private and intimate space. This is achieved in a number of ways:
The behavior of the curtains 110 may be such that it creates a surrounding space that is smaller to accommodate the need for privacy and to facilitate the activity that is going on in the space. For this purpose, curtains may come down from the ceiling or move up to the ceiling, turn around, move from a rail to the right position or extend (lengthen).
The light effect on the ceiling and/or inside objects in the space may be adapted to the changed space created by the curtains. Also sound may be adapted accordingly to create a total ambient experience that is adapted to the activity and space dimensions.

For mental wellness and relation purposes, the behavior of the space can create an atmosphere for relaxation, meditation, doing rhythmic/paced breathing etc. which will assist people to release stress. This may be a preprogramed ambient experience behavior (of curtain behavior, light, and/or sound) which is triggered and/or adapted by the presence and activity of people within the space.

The organizing system 100 hence provides a new method to adapt an ambient experience environment to accommodate for the necessary privacy of people. Curtains are used to redefine the dimensions of the space based on the activity of one or more persons within that space. In an adaptable way the curtains can be raised (to make the space bigger) or come down (to create a smaller space).

In other embodiments of the invention, curtains might not only extend (e.g. come down from a ceiling) and retract, but may also be translated, rotated and/or lengthened. FIG. 4 illustrates an example of an organizing system 200 in which curtains 210 can also turn (about a vertical axis, perpendicular to the drawing plane), besides going up and down. In the shown state, the curtains 210 are arranged radially about in inner compartment (equipped with e.g. a proximity sensor 230) in a primary room 201. In general, the curtains 210 can come from the ceiling and/or move over a rail system from the side.

As already indicated above, it is possible that not only the space adapts its dimensions with curtains, but that also light effects on the ceiling and/or audio adapt to create a mental wellness space where people can relax, meditate, do rhythmic/paced breathing exercises etc. The space hence includes a total ambient experience with audio and light to help people for stress relieve/stress prevention and treatment and relaxation. Moreover, a projector or wall washing colored light source could be embedded inside the ceiling to project on a curtain. This may be useful for changing the theme and feeling of the space easily. In general, any actuator that can enhance the ambiance can be added to the system, including further examples such as airflow control (e.g. climate control, air conditioning/flow), scent release, tactile feedback (e.g. in the floor or via airflow), or humidity control.

In summary, it was described how to adapt an ambient experience environment to accommodate for the necessary privacy of people. Curtains are used that redefine the dimensions of the space based on the activity of one or more people within that space. In an adaptable way the curtains can be raised (to make the space bigger) or come down (to create a smaller space). The presence of people can for example be detected by weight sensors in the floor or via a camera and video processing. Based on this, the behavior can be programmed in such way that the space will transform itself around the person to create an intimate and private space, and the presented ambient experience with light and sound may adapt accordingly. The proposed approach offers a benefit because the space around a person is adaptable in its size and form.

The invention can be applied in a home environment, but also in healthcare environments, for example in spaces where patients undergo a medical scanning procedure or in emergency rooms in hospitals where sometime a private space is needed or in patient wards where privacy is needed on an ad-hoc basis. Another application may be at tradeshows and exhibition spaces. For tradeshow organizers, the spaces that they offer could include a system as described above. For different exhibitors the space can then be easily customized to create the right atmosphere for their (commercial) purposes.

Furthermore, the invention may be used in shops, for example in clothing shops, where there is a great need to use spaces more flexible. A changing space may for instance readily be created or resized based on the needs of clientele. Also when the offer in the shop changes, the system can be used to create semi-closed sections for different cloths or change the route (with curtains) based on the amount of people.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measures cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. A room organizing system for shaping a living area in a primary room, comprising:
at least one curtain that is controllable between an extended state, in which it subdivides the primary room into at least two compartments such that each compartment can be used by a person, and a retracted state;
at least one sensor for providing detection signals (s) related to a state of usage of the primary room;
a controller for controlling the at least one curtain in dependence on the detection signals (s) of the at least one sensor.

2. A method for shaping a living area in a primary room, said method comprising the following steps:
sensing a state of usage of the primary room;
controlling the extension and retraction of at least one curtain according to the sensed state of usage, wherein the at least one curtain subdivides the primary room into at least two compartments when being extended such that each compartment can be used by a person.

3. The system according to claim 1,
characterized in that the curtain is provided in a mounting system that allows for a translation, rotation, and/or lengthening of the curtain.

4. The system according to claim 1,
characterized in that there is a plurality of independently controllable curtains that allows for different patterns of subdivisions of the primary room.

5. The system according to claim 1,
characterized in that at least one compartment can be created that is completely bordered by one or more curtains.

6. The system according to claim 1,
characterized in that the presence, identity, state, location, orientation, movement, and/or activity of a user (P) or of an object is or can be detected.

7. The system according to claim 1,
characterized in that the sensor comprises at least one element selected from the group consisting of a weight sensor, a proximity sensor, a sensor of a physiological parameter, a wireless communication device, an RFID reader, and a camera.

8. The system according to claim 1,
characterized in that an input device is provided via which a user (P) can deliberately affect the control of the curtain.

9. The system according to claim 1,
characterized in that at least one of a light source, a sound system, an image projection system, a climate control, a scent release, and a tactile feedback is provided that is controlled according to the detected state of usage.

10. The system according to claim 1,
characterized in that at least one compartment providing conditions of wellness and/or relaxation can be provided.

11. The method according to claim 2,
characterized in that an area in a home environment, in a hospital, in an office, at an exhibition, in a shop, in a restaurant, in a theater, or in other public spaces is shaped.
